(19) United States
(12) Patent Application Publication
(10) Pub. No.: US 2021/0229361 A1
(43) Pub. Date: Jul. 29, 2021

(54) 3-D PRINTER WITH GAS EXCHANGE MECHANISM FOR REMOVING CONTAMINANTS DURING RE-COATING

(71) Applicant: DIVERGENT TECHNOLOGIES, INC., Los Angeles, CA (US)

(72) Inventors: Broc William TenHouten, Los Angeles, CA (US); Eahab Nagi El Naga, Los Angeles, CA (US)

(21) Appl. No.: 16/774,982

(22) Filed: Jan. 28, 2020

(51) Int. Cl. B29C 64/35; B29C 64/153; B29C 64/214; B29C 64/264; B29C 64/364; B29C 64/255

(52) U.S. Cl. CPC B29C 64/35; B29C 64/153; B29C 64/214; B33Y 40/00; B29C 64/364; B29C 64/255; B29C 64/264

(57) ABSTRACT

Techniques for cleaning a print chamber using a gas exchange structure and a re-coater are introduced. The gas exchange structure is coupled to the coater, and the two move in a same direction to benefit from the gas flow. In an embodiment, the gas exchange structure includes a manifold. Further, in an embodiment, a travelling wall may be coupled to a longitudinal axis of the re-coater in order to keep separate the clean chamber from the dirty chamber. The result is that gas contaminants caused largely by the fusion and melting processes are removed from the powder bed and chamber at each cycle, and the resulting 3-D produced component maintains a very high quality for a long period of time.

### BACKGROUND

### Field

The present disclosure relates generally to additive manufacturing, and more specifically to techniques for preventing atmospheric contamination in the chambers of three-dimensional printers.

### Background

Additive Manufacturing (AM) processes involve the use of a stored geometrical model for accumulating layered materials on a ‘build plate’ to produce three-dimensional (3-D) dimensional (3-D) objects having features defined by the model. AM techniques are capable of printing complex components using a wide variety of materials. A 3-D object is fabricated based on a computer aided design (CAD) model. The AM process can create a solid three-dimensional object using the CAD model.

Powder Bed Fusion (PBF) is an exemplary type of AM process, and one of many that includes the problems for which this disclosure is addressed to remedy. PBF uses one or more lasers or other energy beams (such as flowing electrons) along with reflective sources to selectively sinter or melt powder deposited via controller instructions in a powder bed. The selective melting bonds the powder particles together in targeted areas to produce one of myriad layers of a 3-D structure (or a plurality thereof) having the desired geometry, which originated as a 3-D CAD model and then was sliced by other software to produce a layered representation of the 3-D objects. Different materials or combinations of material, such as metals, engineering plastics, thermoplastic elastomers, metals, and ceramics may be used in PBF to create the 3-D object. Other more advanced AM techniques, including those discussed further below, are also available or under current development, and each may be applicable to the teachings herein.

Between PDF print cycles described above are re-coat cycles, in which a re-coater uses a level, blade, or rolling member to deposit another layer of powder over the last. After the re-coat, the print process can repeat again to produce another layer

Particularly during the print cycle, different types of three-dimensional (3-D) printers may be exposed to contaminated gas and other particulates like soot that result from various 3-D printer operations such as fusing layers of powder. In most 3-D technologies, however, it is imperative to maintain a clean gas chamber, primarily to avoid adversely affecting printing phenomena that might corrupt the build pieces. More specifically, soot-free gas helps ensure that the material properties of the print layers are clean and well-controlled, thus assuring printed parts with predictable thermal and material properties. In addition, the gas chambers left untreated after the print cycles, accumulate soot and other damaging particulates that worsen over time.

### SUMMARY

Various aspects of the disclosure are set for providing controlled gas exchange during re-coat to ensure expedient removal of contaminated gas from the chamber and for keeping clean the chamber gas during following cycles.

According to one aspect of the disclosure, an apparatus to produce a three-dimensional (3-D) structure includes a re-coater disposed within a build chamber, the re-coater for traveling over a powder bed to deposit powder layers during a re-coat cycle, each layer being selectively exposed to an energy source during a print cycle following the re-coat cycle to produce the 3-D structure, and a gas exchange structure configured to travel with the re-coater to remove contaminated gas and to add clean gas during the re-coat cycle.

In another aspect of the disclosure, a method for producing a three-dimensional (3-D) structure, includes performing a re-coating operation in a build chamber within which the 3-D structure is produced, wherein a re-coater disposed within the build chamber travels over a powder bed to deposit powder layers during a re-coat cycle, each layer being selectively exposed to an energy source during a print cycle following the re-coat cycle to produce the 3-D structure, and performing a gas exchange with a gas exchange structure configured to travel with the re-coater to remove contaminated gas and to add clean gas during the re-coat cycle.

Other aspects will become readily apparent to those skilled in the art from the following detailed description, wherein is shown and described only several embodiments by way of illustration. As will be realized by those skilled in the art, concepts herein are capable of other and different embodiments, and several details are capable of modification in various other respects, all without departing from the present disclosure. Accordingly, the drawings and detailed description are to be regarded as illustrative in nature and not as restrictive.

### DESCRIPTION OF THE DRAWINGS

Various aspects of the methods and apparatuses for gas exchange within an apparatus for producing a 3-D structure will now be presented in the detailed description by way of example, and not by way of illustration, wherein:

FIGS. 1A-1D illustrate a conceptual side view of an example of a powder bed fusion

(PBF) system during different stages of operation.

FIG. 2A shows a side view of a 3-D print chamber using a powder bed with a re-coater to apply and smoothen a layer.

FIG. 2B shows a side view of a 3-D print chamber having a powder bed and using a re-coater with a manifold and a vertical member above the manifold to clean the contaminated gas accrued during the fusion cycle.

FIG. 2C shows a side view of a 3-D print chamber during a re-coat cycle, where a traveling wall is built to the size of the chamber to include an inlet and outlet to pass the dirty gas and introduce the clean gas, respectively.

FIG. 3 is a top down view of a 3-D printer system according to another embodiment, wherein the manifold secured to a longitudinal axis of the re-coater.

FIG. 4 is a conceptual block diagram of various techniques used for removing contaminate gas in certain embodiments of the present disclosure.

### DETAILED DESCRIPTION

The detailed description set forth below in connection with the appended drawings is intended to provide a description of various exemplary embodiments of maintaining clean, contaminant-free AM environments and is not intended to represent the only embodiments in which the invention may be practiced. The terms “exemplary” and “example” used throughout this disclosure mean “serving as an example, instance, or illustration,” and should not necessarily be construed as preferred or advantageous over other embodiments presented in this disclosure. The detailed description includes specific details for the purpose of providing a thorough and complete disclosure that fully conveys the scope of the invention to those skilled in the art. However, the invention may be practiced without these specific details. In some instances, well-known structures and components may be shown in block diagram form, or omitted entirely, in order to avoid obscuring the various concepts presented throughout this disclosure.

This disclosure is generally directed to using AM techniques to build different types of 3-D structures, where large build chambers may often be needed and where the removal of contaminated gases may be paramount to avoiding progressively increased corruption of the resulting 3-D structures. In some instances, these techniques may be used in, for example, assembly of modular components for vehicles and other transport structures. As shown below, the combination of the additive manufacturing techniques with enhancements to the way in which potentially detrimental byproducts and gaseous contaminants are removed may provide advantages to the long term production of different types of components. In addition, such techniques can provide distinct advantages to a manufacturer. Small 3-D printer that produce high-precision components may equally benefit from these procedures.

As such, in an aspect of the disclosure, a re-coat cycle is used for more than deposition of powder layers in preparation for the next print cycle. That is to say, in an embodiment, a gas exchange structure is coupled to the re-coater on both sides such that the re-coater and gas exchange structure move in a same travel direction. On a leading edge of the re-coater, contaminated gas is input into the gas exchange structure in part due to the movement of the re-coater, the latter of which may concurrently be depositing a fresh powder layer in preparation for the next cycle.

Meanwhile, on the re-coater's trailing edge, clean gas is output from the gas exchange structure for use in the next print cycle. In an embodiment, the gas exchange structure is a manifold that may use sophisticated de-contaminants including filters. Also, in an embodiment, a traveling wall is coupled to a longitudinal axis of the re-coater to ensure segregation of the clean and contaminated gas between chambers such that, at the conclusion of the re-coat cycle, the entire chamber is substantially contaminant free. The wall may use pistons to achieve benefits from the gas pressure.

Manufacturers that stand to benefit from this proposed combination of features include, but are not limited to, those that manufacture virtually any mechanized form of transport, which often rely heavily on complex and labor intensive machine tools and molding techniques, and whose products often require the development of complex panels, nodes, and interconnects to be integrated with intricate machinery such as combustion engines, transmissions and increasingly sophisticated electronic techniques. Examples of such transport structures include, among others, trucks, trains, boats, aircraft, tractors, motorcycles, busses, trains, and the like. These transport structures tend to be larger than other types of structured manufactured using additive manufacturing techniques and therefore may require enhanced manufacturing equipment and processing techniques.

Additive Manufacturing (3-D Printing). A variety of different AM techniques have been used to 3-D print components composed of various types of materials. Numerous available techniques exist, and more are being developed. For example, Directed Energy Deposition (DED) AM systems use directed energy sourced from laser or electron beams to melt metal. These systems utilize both powder and wire feeds. The wire feed systems advantageously have higher deposition rates than other prominent AM techniques. Single Pass Jetting (SPJ) combines two powder spreaders and a single print unit to spread metal powder and to print a structure in a single pass with apparently no wasted motion. As another illustration, electron beam additive manufacturing processes use an electron beam to deposit metal via wire feedstock or sintering on a powder bed in a vacuum chamber. Single Pass Jetting is another exemplary technology claimed by its developers to be much quicker than conventional laser-based systems. Atomic Diffusion Additive Manufacturing (ADAM) is still another recently developed technology in which components are printed, layer-by-layer, using a metal powder in a plastic binder. After printing, plastic binders are removed and the entire part is sintered at once into a desired metal.

Another AM technique includes powder-bed fusion (“PBF”). Like DMD, PBF creates ‘build pieces’ layer-by-layer. Each layer or ‘slice’ is formed by depositing a layer of powder and exposing portions of the powder to an energy beam. The energy beam is applied to melt areas of the powder layer that coincide with the cross-section of the build piece in the layer. The melted powder cools and fuses to form a slice of the build piece. The process can be repeated to form the next slice of the build piece, and so on. Each layer is deposited on top of the previous layer. The resulting structure is a build piece assembled slice-by-slice from the ground up.

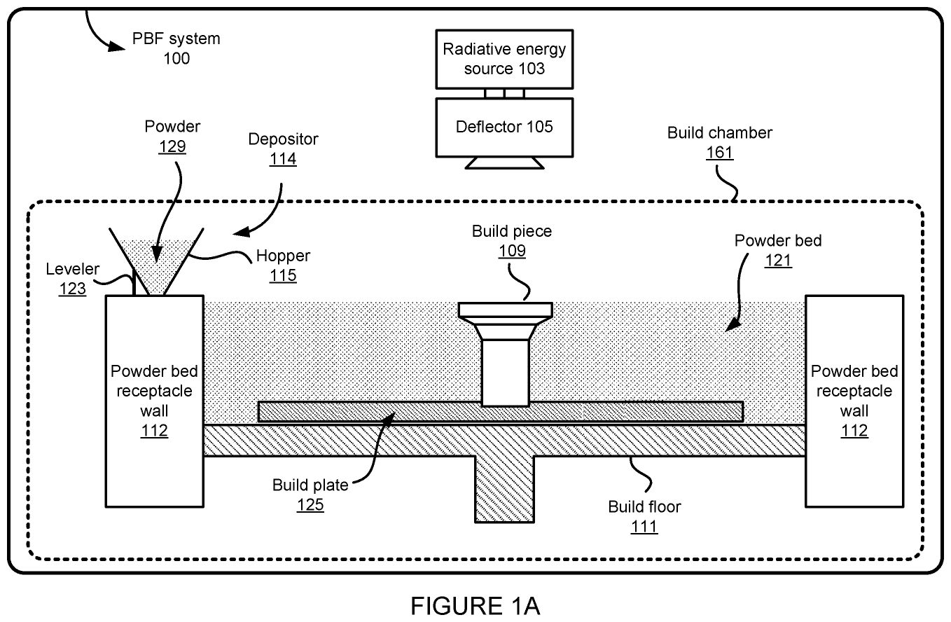

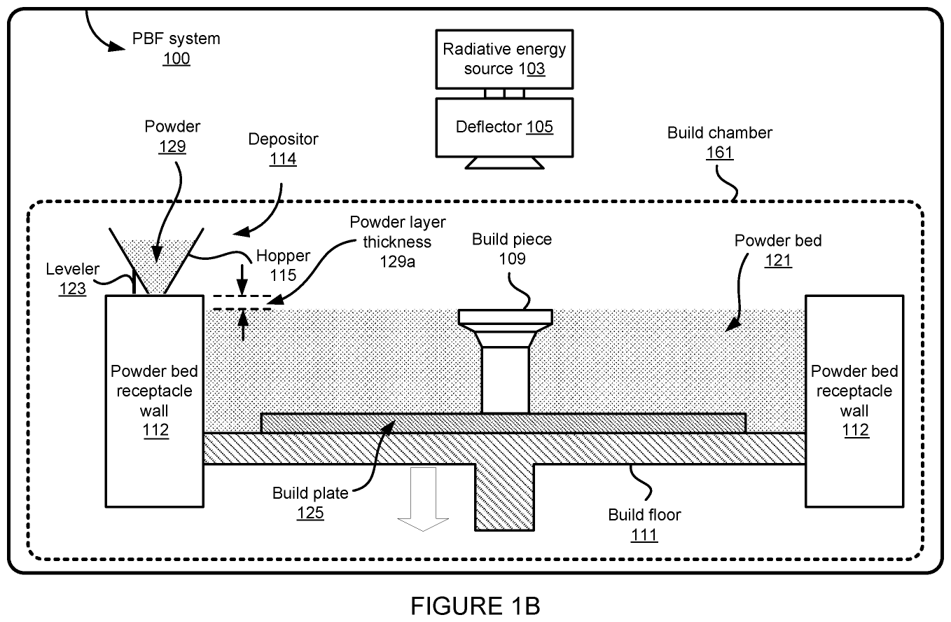

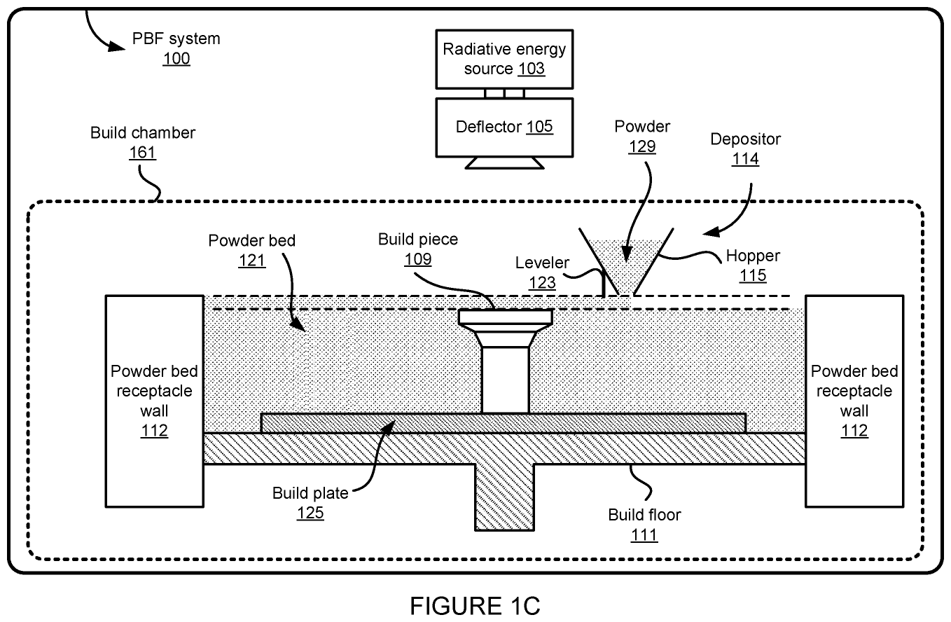

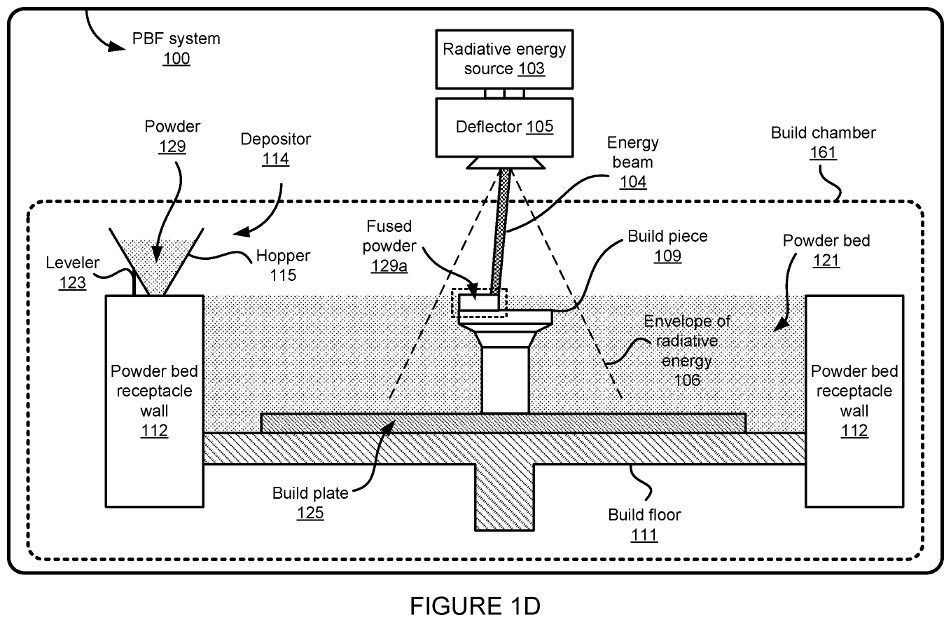

FIGS. 1A-1D illustrate respective side views of an exemplary PBF system 100 during different stages of operation. The particular embodiment illustrated in FIGS. 1A-1D is one of many suitable examples of a PBF system employing principles of this disclosure. It should also be noted that elements of FIGS. 1A-1D and the other figures in this disclosure are not necessarily drawn to scale, but may be drawn larger or smaller for the purpose of better illustration of concepts described herein.

The PBF system 100 can include a depositor 114 that can deposit each layer of metal powder, a radiative energy source 103 that can generate one or more energy beams, a deflector 105 that can apply the energy beam(s) to fuse the powder, and a build plate 125 that can support one or more build pieces, such as a build piece 109. The PBF system 100 can also include a build floor 111 positioned within a powder bed receptacle. The walls 112 (left side) and 112 (right side) of a powder bed receptacle generally define the boundaries of the powder bed receptacle, which is sandwiched between the walls 112 from the side and abuts a portion of the build floor 111 below. The build floor 111 can progressively lower the build plate 125 (see e.g., arrow on FIG. 1B) so that the depositor 114 can deposit a next layer. The entire mechanism may reside in a build chamber 161 that can enclose the other components, thereby protecting the equipment, enabling atmospheric and temperature regulation and mitigating contamination risks. In some implementations, the radiative energy source 103 and/or the deflector 105 can be part of or be included within the build chamber 161. The depositor 114 can include a hopper 115 that contains a powder 129, such as a metal powder, and a leveler 123 that can level the top of each layer of deposited powder.

Referring specifically to FIG. 1A, this figure shows the PBF system 100 after a slice of build piece 109 has been fused, but before the next layer of powder has been deposited. In fact, FIG. 1A illustrates a time at which the PBF system 100 has already deposited and fused slices in multiple layers to form the current state of build piece 111. The multiple layers already deposited have created a powder bed 121, which includes powder that was deposited but not fused.

FIG. 1B shows the PBF system 100 at a stage in which the build floor 111 can be lowered by a powder layer thickness 129a. The lowering of the build floor 111 causes the build piece 109 and the powder bed 121 to drop by the same powder layer thickness 129a, so that the top of the build piece 109 and of the powder bed 121 are lower than the top of powder bed receptacle walls 112 and 112 by an amount equal to the powder layer thickness 129a. In this way, for example, a space with a consistent thickness equal to the powder layer thickness 129a can be created over the tops of the build piece 109 and the powder bed 121.

FIG. 1C shows the PBF system 100 at a stage in which the depositor 114 is positioned to deposit the powder 129 in a space created over the top surfaces of the build piece 109 and the powder bed 121 and bounded by the powder bed receptacle walls 112 and 112. In this example, the depositor 114 progressively moves over the defined space while releasing the powder 129 from the hopper 115. The leveler 123 can level the released powder to form a powder layer that has a thickness substantially equal to the powder layer thickness 129a (see e.g., FIG. 1B). Thus, the powder in the PBF system 100 can be supported by a powder support structure, which can include, for example, the build plate 125, the build floor 111, the build piece 109, the powder bed receptacle walls 112 and 112, and the like. It should be noted that as illustrated the powder layer thickness 129a can be greater than an actual thickness used for the example involving previously-deposited layers discussed above with reference to FIG. 1A. In other words, the powder layer thickness 129a can be different for different layers.

FIG. 1D shows the PBF system 100 at a stage in which, following the deposition of a powder layer having the powder layer thickness 129a (FIG. 1C), the radiative energy source 103 generates an energy beam 104 and the deflector 105 applies the energy beam 104 to fuse the next slice in the build piece 109 (e.g., fused powder 129a). In various exemplary embodiments, the radiative energy source 103 can be an electron beam source, in which case the energy beam 104 constitutes an electron beam. The deflector 105 can include deflection plates that can generate an electric field or a magnetic field that selectively deflects the electron beam to cause the electron beam to scan across areas designated to be fused. In various embodiments, the radiative energy source 103 can be a laser, in which case the energy beam 104 is a laser beam. The deflector 105 can include an optical system that uses reflection and/or refraction to manipulate the laser beam to scan selected areas to be fused. In either case, the energy beam 104 may have an associated envelope of radiative energy 190 that represents a potential coverage of the energy beam 104 or a spread of the energy associated with the energy beam 104.

In various embodiments, the deflector 105 can include one or more gimbals and actuators that can rotate and/or translate the radiative energy source 103 to position the energy beam 104. In various embodiments, the radiative energy source 103 and/or the deflector 105 can modulate the energy beam 104, e.g., turn the energy beam 104 on and off as the deflector 105 scans so that the energy beam 104 is applied only in the appropriate areas of the powder layer. For example, in various embodiments, the energy beam 104 can be modulated by using signals generated by a digital signal processor (DSP) or other similar signal generating devices or components.

During the print cycle where the fusion process occurs, generally a gas flow in the chamber is required. Thus, for example, a large vapor cloud may shoot off to one side of the chamber while the energy beam fuses the powder material. The soot creation is an artifact of the fusing process. The soot must be removed because it likely contains impurities and moisture that results in the contaminated gas. The contaminated gas likely includes oxygen, which tends to undesirably oxidize portions of the build piece. Thus, one desirable goal is to prevent the suit from resettling onto the chamber, which reduces future powder quality. The gas also tends to dirty the laser “window(s)” through which the mirrors emit light at the top of the chamber, and the opacity of which reduces effectiveness of the mirrored material. The contaminated gas can glaze the optics and diffract the laser, creating a lower quality laser.

Conventional approaches use a stationary manifold in the chamber to collect the contaminants and introduce clean gas into the chamber. The manifold often jets gas at high speeds at the lower portion of the powder bed, where the soot is most likely to settle and cause the problems identified above. One problem with the conventional approach is that the high speed manifolds also remove a portion of the powder layer by virtue of the speed of the gas flow, producing burrs in the powder layers. The burrs introduced into the powder can compromise the quality of the build piece. The problem is exacerbated with larger build areas, where larger burrs tend to form on the build. The gas flow dynamics used in these traditional approaches also place overall limitations on the width of the machine.

In addition to the high speed gas flow, low speed gas exchange tends to be more problematic because it can cause turbulence in the weld pool, which negatively affects the fusion process itself. Thus another function of the stationary manifold is to reduce this turbulence. That is to say, high speed gas is also used to remove slower accumulating soot deposition. As noted above, however, high speed gas has its own problems with the stripping of the powder layers.

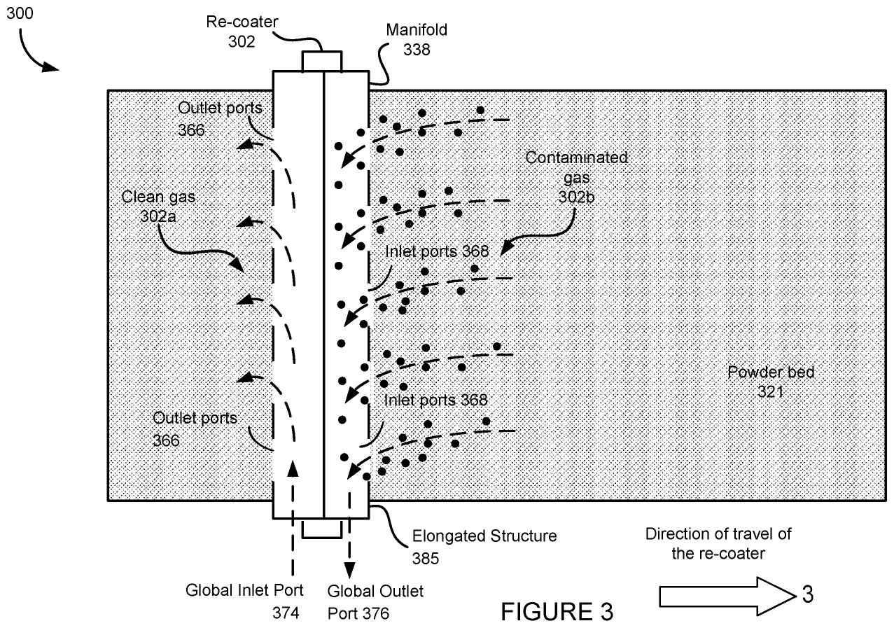

Consequently, modern approaches have attempted to address some or essentially all of these problems. In one aspect of the disclosure, a moveable gas exchange manifold system is implemented with the re-coating mechanism to provide for controlled, wholesale gas exchange during the re-coat process between print cycles. Manifold as used herein can mean a pipe or chamber branching into two or more openings, or it can mean one or more pipes, or a network of channels, that has the effect by itself or in concert with other processes, moving gas and contaminants out of the chamber and clean gas into the chamber. The manifold can include other artifacts in some embodiments, such as small fans or other mechanisms to induce air flow, one-way valves, filters, and the like. The re-coat process ordinarily uses a re-coater to apply and finely brush a next even layer of powder onto the build plate, between print cycles. A large number of types of re-coaters exist and their properties are often dependent on the type of printer. For instance, in the 3-D printer of 1A-1D, the re-coater mechanism can be integrated into the bottom portion of the hopper 115. In this manner, the re-coater can receive powder material from the hopper 115 and, as in FIG. 3 during a re-coat cycle, the re-coater and hopper can collectively slide across the powder bed to apply a powder using what is typically the re-coater's leveler 123.

In other 3-D printers, the re-coater does not directly involve the hopper 115. For example, the re-coater may be a soft re-coater or a hard re-coater. A soft re-coater has blades made from silicon, rubber or soft carbon fiber (for instance a brush re-coater) and spreads the powder from one side of the build platform to the other. Because of its flexibility, the soft re-coater can give way slightly in case of a collision with any metal parts being built. Soft re-coaters also get damaged more easily. A hard re-coater has blades made of HS steel or ceramic and exerts pressure on the powder. This type of re-coater, in comparison with the soft re-coaters, doesn't allow much part deformation.

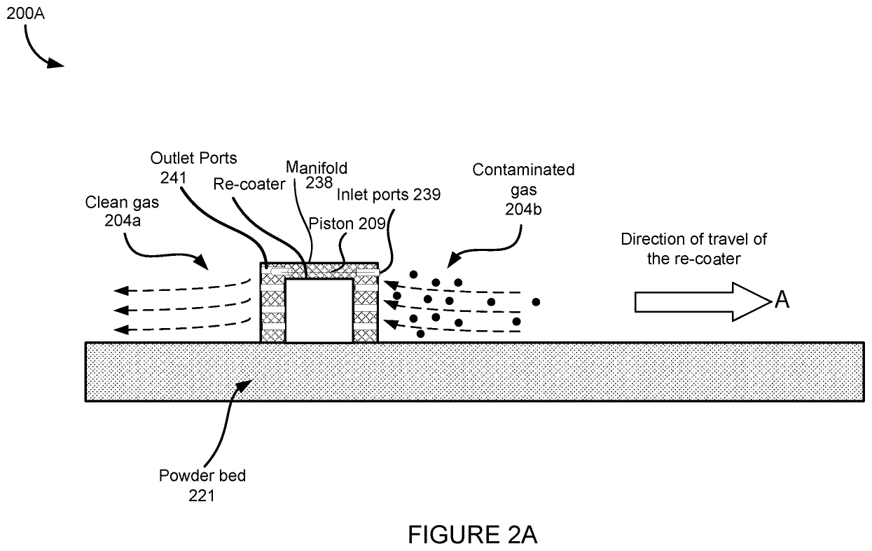

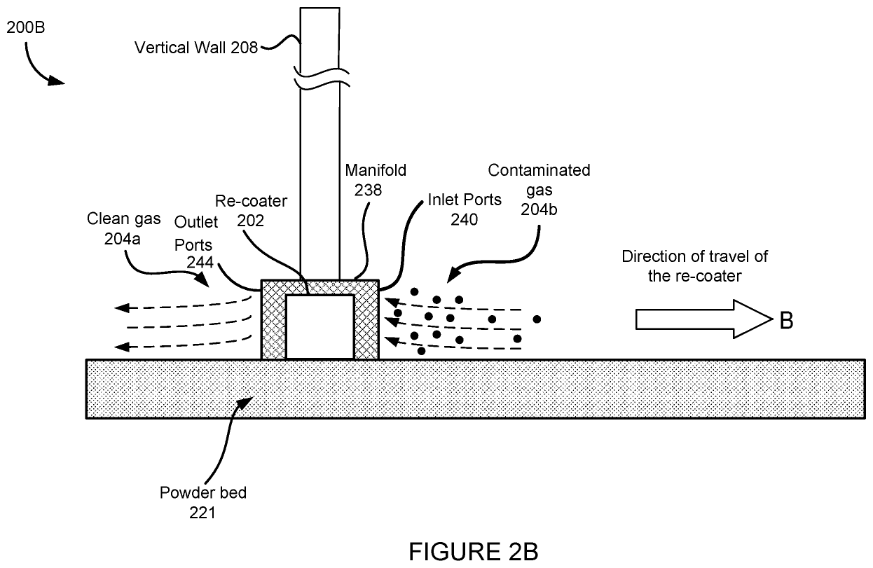

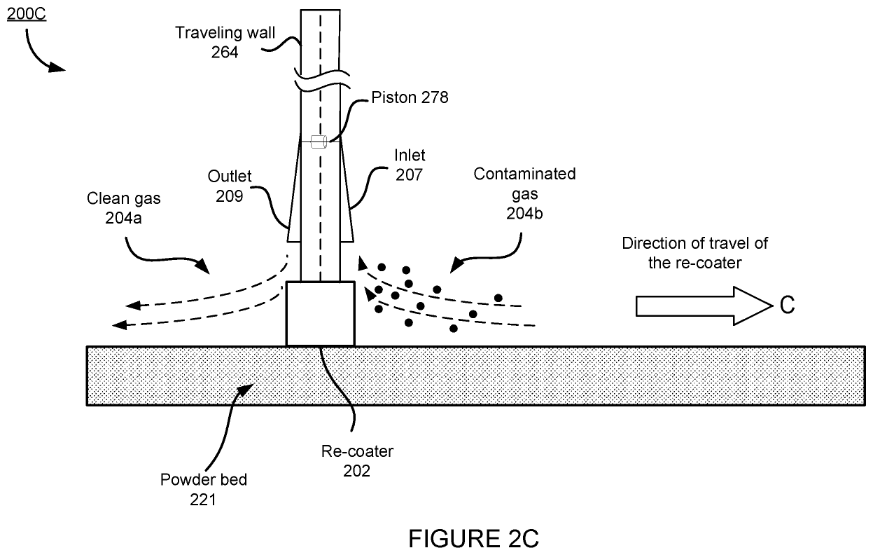

FIG. 2A shows standard parts of a 3-D printer 200A using a powder bed 121 and a re-coater 202 to apply and smoothen a layer. Embedded with re-coater 202 is a gas exchange structure, which may include a manifold 238. The manifold moves along with re-coater 202 as the re-coater moves from left to right on the powder bed 221 to apply a layer for a subsequent print cycle, as shown conspicuously by the arrow A on the right side of the figure. For simplicity, the build piece is omitted from the illustration, but it is assumed that one or more protrusions corresponding to the build piece are just under the layer being applied. The manifold may include a number of pipes or other channels, which may be further portioned into a plurality of inlets and a plurality of outlets through which contaminated or clean gas may flow, as the case may be. The plurality of inlets may be coupled to at least one inlet port disposed on one side of the manifold. Similarly, the plurality of outlets may be coupled to at least one outlet port disposed on an opposite side of the manifold. In various embodiments, the plurality of inlets and/or the plurality of outlets may include only a single inlet and a single outlet.

One advantage of this approach is that, because the manifold 238 is being moved in the context of a re-coat cycle rather than a print cycle, the activities of the manifold 238 do not interfere with the print fusion activities. The manifold used in 3-D printing can be similar in operational principle to an exhaust manifold, which is an engine part with a plurality of inlet ports 239 designed to collect “exhaust” or other contaminate gases from multiple cylinders into a single pipe, where the gas 204b can be filtered and the contaminants disposed of While the inlet ports 239 can take on a variety of geometric configurations and the manifold in principle can use arbitrary levels of complexity, a few horizontal inlet parts 239 are shown for illustrative purposes.

Thus, FIG. 2A shows a plurality of exemplary inlet ports 239 (such as, for example, pipes) for receiving contaminated gas 204b. One or more of inlet ports 239 and outlet ports 241 can also include one or more pistons, such as piston 209, for compressing air as described below. Inlet ports 239 are present on the right side of manifold 238, and outlet ports 241 are on the left side of manifold 238. Inlet ports 238 may include pistons, for example, or pipes that pass the contaminated gas 204a to a filter, or use some other mechanism. A number of configurations of the inlet ports and outlet ports are possible. For example, a single inlet port and a single outlet port may be used in some embodiments. Likewise, since the manifold is arranged adjacent the re-coater, a number of geometrical variations of the manifold and its constituent elements may be used in different embodiments. In the embodiment of FIG. 2A, the manifold can: receive or collect contaminated gas 204(b) (e.g. via inlet ports 239); filter or otherwise separate the contaminated gas 204(b) from the atmosphere in the chamber; and eject clean gas (e.g., via outlet ports 241 on the left side of manifold 238). Alternatively or additionally, the manifold 238 may make use of pistons (within pipes, for example) to trap the contaminants and force clean air to exit the left side thereof. The outlets ports 241 in some embodiments may be a single pipe, or an array or network of pipes, or a channel having another shape. The geometry of the inlet ports 239 and outlet ports 241 is shown for exemplary purposes only, and each may be configured in a manner that accomplishes the stated objectives.

Also, in some embodiments, one or more filters can be included within the manifold (obscured from view) for segregating the contaminated particles received at one or more inlet ports 239. Thus, outlet ports 241 such as pipes on the left side of the re-coater 202 may be used to outlet clean air into the chamber. For example, the inlet ports 239 on the right may be exhaust pipes or channels that collectively lead the contaminants to a manifold filter, after which clean gas 204a may be free to move out of one or more outlet ports 241 on the left side of the chamber relative to the re-coater 202.

Referring still to FIG. 2A, as the re-coat cycle is underway, a significant amount of the contamination may be found close to the surface of the powder bed 221, in part because the lasers targeted specific areas of the powder bed 221 during the immediately previous print cycle. As the manifold 238 and re-coater 202 move at a fast clip in the travel direction of the re-coater 202, the re-coater is allowed to deposit a new layer without distortion, and contaminated gas 204b meets the front surface of the manifold 238. The pressure caused by movement of the contaminated gas 204b and the manifold 238 may be used for the benefit of removing the contaminated particles. For example, the contaminated gas 204d may enter the manifold via inlet ports 239 and may compress a piston 209 (or plurality thereof) within the manifold 238, which in turn traps the contaminants, e.g., within a volume defined by the compressed piston. Meanwhile, the piston as it is compressed and moved into a leftward position applies a pressure causing clean gas 204a to be released from the manifold 238, e.g., via outlet ports 241, or directly from the piston(s). More than one piston may be used for this purpose. Alternatively or additionally, the manifold 238 may use one or more filters designed to contain the contamination while allowing clean air to exit out the left portion of the gas exchange structure (e.g., via outlet ports 241) and into the left portion of the chamber as the re-coater 202 completes the re-coat cycle by moving the remaining way to the right.

FIG. 2B shows a side view of a 3-D printer 200B having a powder bed 221 and using a re-coater 202 with a manifold 238 and a vertical wall 208 above the manifold to contain and therefore clean the contaminated gas accrued during the fusion cycle. The vertical wall 208 may be coupled to the gas exchange structure (e.g., the manifold), or the re-coater 202, or both. In some embodiments, the vertical wall 208 may be part of the gas exchange structure. In this embodiment, the manifold 238 is also integrated with the re-coater 202, such that as re-coating is conducted in the direction of travel identified by the arrow B, a gas exchange can be conducted as well. If the direction of travel of the re-coater is toward the right, for example, the contaminated gas can be sucked in from the right by the inlet port 240 (which may include one or more inlets or a single larger vent, etc.) of the manifold 238 and the clean gas introduced on the left of the manifold 238. As the re-coater 202 reaches the far right at the end of the re-coater cycle, pressure continues to build on the right side of the vertical wall 208 in the chamber, meaning that most of the leftover contaminated air 204b is encouraged to enter the inlet port 240. Given this pressure build-up, the remaining clean air (e.g., filtered air, pressurized clean air, etc.) can exit via outlet port 244 (which may again be one or more outlets or vents) of the manifold 238 on the left side.). It will be appreciated that, due to the variety of possible configurations of the manifold and its internal construction, inlet ports 240 and outlet ports 244 are not specifically shown. Rather, the lines designating these ports reference applicable sides of the manifold 238 in which the ports would reside.

In an embodiment, the wall 208 spans the entire width of the chamber 200B (that is, into and out of the page as necessary Accordingly, the embodiment means that all contaminated gas has nowhere to travel but into the input gas pipes (e.g., inlet ports 240) of the manifold 238 as the re-coating finalizes. This trapped contaminated gas within the manifold 238 may be held in a filter internal to the manifold 238 or otherwise disposed of outside the chamber in another confined location. The clean gas 204a can then exit the manifold onto the left side of powder bed 221, e.g., via outlet ports 244. Next, after the re-coater 202 and manifold 238 move off the powder bed 221, the energy beam source is ready to begin the fusion process for that cycle.

In still another embodiment, a manifold is not integrated with the re-coater. FIG. 2C shows a side view of a 3-D print chamber 200C during a re-coat cycle, where a traveling wall is built onto the chamber to include an inlet and outlet gas chamber or other mechanism to pass on the dirty gas. In this embodiment, the re-coater 202 excludes the manifold and therefore need not give special considerations to manifold aspect ratio. The re-coater 202 excludes a manifold but like the previous embodiment of FIG. 2B, it includes a traveling wall coupled to the re-coater and extending across the chamber.

Further, unlike the traveling wall embodiment of FIG. 2B, the wall 264 itself in FIG.

2C includes an inlet 207 for collecting contaminated gas, and an outlet 209 for dispersing clean gas on the left side. As the re-coater 202 continues right in the direction of the arrow C to deposit a layer of powder, an embedded port on the right interior of the traveling wall 264 is collecting contaminated gas, while a port on the left side of the wall can introduce clean gas through an outlet 209. The wall may include a piston 278 or plurality thereof. In various embodiments, the piston 278 may be arranged in sealed pipes within traveling wall 264. Compression of the contaminated gas as it enters the traveling wall 264 may move an internal piston, which may compress the piston in an amount sufficient to force clean gas to exit the wall 264 on the other side. In some embodiments, the piston may force the dirty gas into a filter compartment while concurrently releasing clean gas from a port on the left side of the wall 264 as the re-coater 202 returns from right to left. One advantage of this embodiment is that the powder bed 221 is only physically contacted by the re-coater device 202 as in normal operations. In still another embodiment, the traveling wall 264 of FIG. 2C is connected to a gas manifold, which in turn is coupled to the re-coater. These availability of these options for cleaning the chamber help ensure its integrity for many cycles.

In another view of the embodiment involving only the manifold, FIG. 3 is a top down view of a 3-D printer system 300 according to another embodiment. During a re-coat cycle, the re-coater 302 is shown extended as across the powder bed 321. The manifold 338 extends as part of an elongated structure 385 across the length of the re-coater 302. In this embodiment, the manifold 338 can be seen at the right side of the powder bed 321 in the form of inlet ports 368 (such as pipes, etc.) for the passage of contaminated gas 302b on the right side of powder bed 321. Also, in this embodiment, the manifold 338 can be seen at the left side of the powder bed 321 in the form of outlet ports 366 (such as pipes, etc.) for the passage of clean gas 302a into the left side of the chamber. The manifold 338 also has global inlet port 374 and global output port 376. The global input port 374 is defined by the left output arrows for the entering (into the chamber) of clean gas 302a. The global output port 376 is defined by the right input arrows for the exiting of contaminated gas 302b and entry into appropriate locations in the manifold 338. The inlet ports 368 for contaminated gas 302b can be positioned adjacent a leading edge of the re-coater 302 (relative to the left-right movement of the re-coater) to remove the contaminated gas. The outlet ports for clean gas 302a can be positioned adjacent a trailing edge of the re-coater to introduce the clean gas.

As the re-coater 302 travels in the direction of the arrow 3 to deposit another successive layer, the contaminated gas 302b is forced to flow into the array of inlet ports 368 on the right of the manifold 338, and down into the global outlet port 376 at main exit for the contaminants off of the powder bed 321. In the same manner, since the manifold 338 began at the far left of the powder bed 321 the clean gas 302a will be forced to enter the global inlet port 374 on the left, after which it will be distributed out into the area to the left of the manifold 338 as the clean gas 302a passes through the array of outlet ports 366 as the clean gas 302a begins to populate the powder bed. As the re-coater 302 reaches the far right of the powder bed 321, in one embodiment it can move to a side of the powder bed 321 to permit another print cycle to occur using the clean gas.

In general, a re-coat can last about fifteen second in small machines. In larger machines, e.g., with higher laser, the re-coat delay becomes greater. Thus the size of the manifold and the amount of time to clear the contaminants from the powder bed is initially very small but can increase with the overall size of the printer.

A re-coater may be configured in different ways depending on the print technology.

In the powder based fusion configuration, as one example, the re-coater may be configured to be a lower part or base of the hopper that includes the leveler. The re-coater may traverse across a surface of the powder bed to add a layer of powder in an even manner to the powder bed. In alternative embodiments, the re-coater may include a roller for applying and leveling the powder. As noted above, in some embodiments, the hopper may be directly involved in traversing a surface of the powder bed.

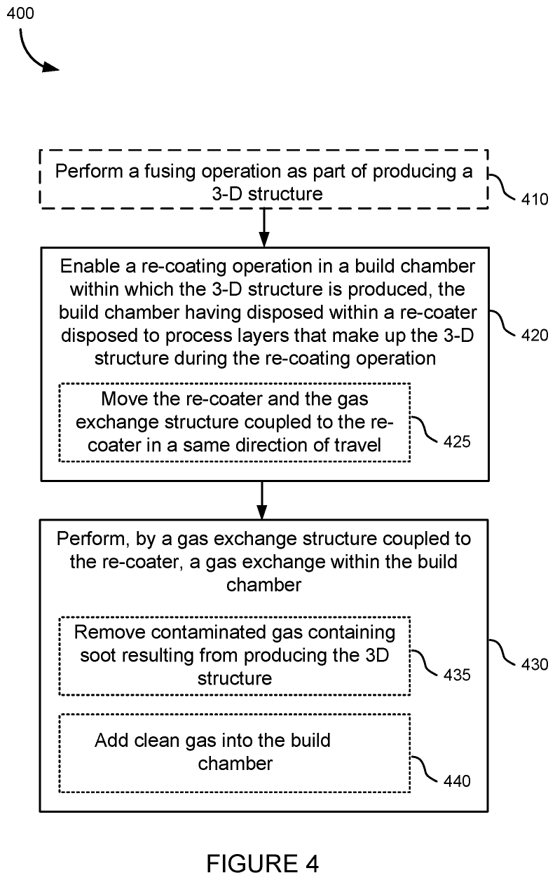

FIG. 4 is a conceptual block diagram of various processes used in certain embodiments of the present disclosure. Step 410 represents a print cycle, namely performing a selective fusing operation on a layer of powder on a powder bed, which is one of many steps that are part of printing a 3-D structure. Various different energy beam sources, including lasers, electron beams, and other energy sources, can be used in this step.

Step 420 generally references the re-coat cycle that follows the print cycle to deposit another layer of powder down on the print bed prior to the next print cycle. Thus upon completion of the latest print cycle, the controller can enable a re-coating operation in a build chamber (i.e., the chamber within which the 3-D structure is produced), such that the build chamber has arranged within the chamber a re-coater configured to process and deposit the layers that will make up the 3-D structure, at least in part, during the subsequent print operation. In an embodiment shown by step 425, the re-coater and gas exchange structure (e.g., manifold, gas exchanging wall) are moved in a same direction of travel to ensure that the contaminants are removed at the right time.

Next, in step 430, the gas exchange structure coupled to the re-coater performs a gas exchange within the build chamber. In a first part of this step 435, contaminated gas containing soot resulting from producing the 3-D structure is removed. In a second part of this step 440, clean gas is introduced into the build chamber.

The previous description is provided to enable any person skilled in the art to practice the various aspects described herein. Various modifications to the exemplary embodiments presented throughout this disclosure will be readily apparent to those skilled in the art, and the concepts disclosed herein may be applied in other contexts and for different purposes. Thus, the claims are not intended to be limited to the exemplary embodiments presented throughout the disclosure, but are to be accorded the full scope consistent with the language claims. All structural and functional equivalents to the elements of the exemplary embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. An apparatus to produce a three-dimensional (3-D) structure, comprising:
a re-coater disposed within a build chamber, the re-coater for traveling over a powder bed to deposit powder layers during a re-coat cycle, each layer being selectively exposed to an energy source during a print cycle following the re-coat cycle to produce the 3-D structure; and
a gas exchange structure configured to travel with the re-coater to remove contaminated gas and to add clean gas during the re-coat cycle.

2. The apparatus of claim 1, wherein the gas exchange structure is coupled to the re-coater.

3. The apparatus of claim 2, further comprising a wall coupled to the re-coater or the gas exchange structure and having a length disposed along a longitudinal axis of the re-coater and a height extending vertically above the powder bed, the wall being configured to travel in the same direction as the re-coater.

4. The apparatus of claim 1, wherein the gas exchange structure includes a manifold.

5. The apparatus of claim 4, wherein the manifold includes:
one or more inlets into which the contaminated gas from the build chamber flows, wherein the contaminated gas comprises soot resulting from producing the 3-D structure; and
one or more outlets to add the clean gas into the build chamber.

6. The apparatus of claim 5, wherein:
the one or more inlets are connected to at least one inlet port on a side of the manifold, wherein the contaminated gas is input from the build chamber via the at least one inlet port, and
the one or more gas outlets are connected to at least one outlet port on another side of the manifold, wherein the clean gas added into the build chamber via the at least one outlet port.

7. The apparatus of claim 6, wherein:
the at least one inlet port is positioned adjacent a leading edge of the re-coater to remove the contaminated gas from the chamber, and
the at least one outlet port is positioned adjacent a trailing edge of the re-coater to introduce the clean gas into the chamber.

8. The apparatus of claim 7, wherein:
the manifold includes a global outlet port and a global inlet port.

9. The apparatus of claim 7, wherein:
the manifold includes an elongated structure disposed along a longitudinal axis of the re-coater,
the at least one inlet port is disposed on one side of the elongated structure, and
the at least one outlet port is disposed on an opposite side of the elongated structure.

10. The apparatus of claim 1, wherein the gas exchange structure includes a wall that includes a first port for removing from the build chamber the contaminated gas and a second port for adding the clean gas into the build chamber.

11. The apparatus of claim 10, wherein the wall includes a movable piston that causes the contaminated gas to be removed and the clean gas to be added.

12. The apparatus of claim 1, wherein the gas exchange structure is configured to perform the gas exchange in a first mode when the re-coater travels in a first direction and in a second mode when the re-coater travels in a second direction.

13. The apparatus of claim 1, wherein the build chamber comprises a chamber configured for powder bed fusion (PBF) additive manufacturing.

14. A method for producing a three-dimensional (3-D) structure, comprising:
performing a re-coating operation in a build chamber within which the 3-D structure is produced, wherein a re-coater disposed within the build chamber travels over a powder bed to deposit powder layers during a re-coat cycle, each layer being selectively exposed to an energy source during a print cycle following the re-coat cycle to produce the 3-D structure; and
performing a gas exchange with a gas exchange structure configured to travel with the re-coater to remove contaminated gas and to add clean gas during the re-coat cycle.

15. The method of claim 14, wherein the gas exchange structure is coupled to the re-coater, coater, such that moving the re-coater causes the gas exchange structure to travel with the re-coater.

16. The method of claim 14, wherein:
the gas exchange structure includes a manifold, and
performing the gas exchange includes:
removing the contaminated gas from the build chamber through one or more gas outlets in the manifold, wherein the contaminated gas contains soot resulting from producing the 3D structure, and adding the clean gas into the build chamber through one or more gas inlets in the manifold.

17. The method of claim 16, wherein:
removing the contaminated gas includes removing the contaminated gas through an output gas port on a side of the manifold, the output gas port being connected to the one or more gas outlets, and
introducing the clean gas includes introducing the clean gas through an input gas port on the side of the manifold, the input gas port being connect to the one or more gas inlets.

18. The method of claim 14, wherein performing the gas exchange comprises:
removing the contaminated gas from the build chamber at a leading edge of the re-coater, and
adding the clean gas into the build chamber at a trailing edge of the re-coater.

19. The method of claim 14, wherein:
the gas exchange structure includes a wall, and
performing the re-coating operation includes moving the re-coater and the wall in a same direction.

20. The method of claim 19, wherein moving the re-coater and the wall in the same direction includes moving the re-coater and the wall in a first direction and subsequently moving the re-coater and the wall in a second direction different from the first direction.

21. The method of claim 19, wherein performing the gas exchange includes activating a movable piston to cause the contaminated gas to be removed from the build chamber and the clean gas to be added into the build chamber.

22. The method of claim 14, wherein:
the gas exchange structure includes a manifold and a wall, and
performing the re-coating operation includes moving the re-coater, the manifold, and the wall in a same direction.

23. The method of claim 21, wherein moving the re-coater, the manifold, and the wall in the same direction includes moving the re-coater, the manifold, and the wall in a first direction and subsequently moving the re-coater, the manifold, and the wall in a second direction different from the first direction.

24. The method of claim 14, wherein performing the gas exchange includes performing the gas exchange in one mode when a direction of travel of the re-coater is a first direction and in a second mode when the direction of travel of the re-coater is a second direction.
